(19) United States
(12) Patent Application Publication
(10) Pub. No.: US 2023/0387633 A1
(43) Pub. Date: Nov. 30, 2023

(54) SHIELD CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hiroyoshi MAESOBA, Osaka (JP); Toshifumi ICHIO, Osaka (JP)

(21) Appl. No.: 18/031,142

(22) PCT Filed: Oct. 1, 2021
(86) PCT No.: PCT/JP2021/036478

§ 371 Date: Apr. 10, 2023

(30) Foreign Application Priority Data
Oct. 22, 2020 (JP) 2020-177468

(51) Int. Cl. H01R 13/6582; H01R 13/6587; H01R 13/639; H01R 13/6599

(52) U.S. Cl. CPC H01R 13/6582; H01R 13/6587; H01R 13/639; H01R 13/6599

(57) ABSTRACT

It is aimed to realize an improvement in shielding performance. A shield connector is provided with a dielectric for accommodating an inner conductor and an outer conductor made of a metal plate material and surrounding the dielectric. The outer conductor includes a box-shaped body portion and a receptacle projecting forward from a front wall portion of the body portion, a mating outer conductor being fit into the receptacle. A rear end part of the receptacle and the front wall portion are continually and electrically conductively connected.

### TECHNICAL FIELD

The present disclosure relates to a shield connector.

### BACKGROUND

Patent Document 1 discloses a shield connector for board in which an inner conductor is surrounded by a dielectric and the dielectric is surrounded by an outer conductor. Since being formed by bending an electrically conductive plate material, the outer conductor is inexpensive as compare to an outer conductor terminal formed by die casting. A side cross-sectional shape of the outer conductor is substantially L-shaped and the outer conductor includes a horizontally extending fitting portion and a board mounting portion extending downward from a rear part of the fitting portion.

### PRIOR ART DOCUMENT

### Patent Document

Patent Document 1: JP H11-339870 A

### SUMMARY OF THE INVENTION

### Problems to be Solved

A lower plate portion of the fitting portion and a front plate portion of the board mounting portion are arranged perpendicular to each other. The lower plate portion of the fitting portion is formed by being bent along the lower end edge of a side plate portion of the fitting portion along. A front surface portion of the board mounting portion is formed by being bent along the front end edge of a side plate portion of the board mounting portion. Thus, it is unavoidable that a cut is formed at a boundary between the rear end edge of the lower plate portion of the fitting portion and the upper end edge of the front plate portion of the board mounting portion. If such a cut is present, there is a possibility that shielding performance is reduced due to the leakage of noise.

A shield connector of the present disclosure was completed on the basis of the above situation and aims to realize an improvement in shielding performance.

### Means to Solve the Problem

The present disclosure is directed to a shield connector with a dielectric for accommodating an inner conductor and an outer conductor made of a metal plate material, the outer conductor surrounding the dielectric, the outer conductor including a box-shaped body portion and a receptacle projecting forward from a front wall portion of the body portion, a mating outer conductor being fit into the receptacle, and a rear end part of the receptacle and the front wall portion being continually and electrically conductively connected.

### Effect of the Invention

According to the present disclosure, it is possible to realize an improvement in shielding performance.

### BRIEF DESCRIPTION OF THE DRAWINGS

FIG. 1 is a perspective view of a shield connector of one embodiment.

FIG. 2 is an exploded perspective view of the shield connector.

FIG. 3 is a side view in section of the shield connector.

FIG. 4 is a side view in section showing a state where the shield connector and a mating connector are connected.

FIG. 5 is a perspective view of a shield terminal.

FIG. 6 is a development of an outer conductor.

FIG. 7 is a side view of the outer conductor before a first conductor portion and a second conductor portion are assembled.

FIG. 8 is a front view of the outer conductor before the first and second conductor portions are assembled.

FIG. 9 is a perspective view of the outer conductor.

FIG. 10 is a side view of the outer conductor.

FIG. 11 is a front view of the outer conductor.

FIG. 12 is a bottom view of the outer conductor.

### DETAILED DESCRIPTION TO EXECUTE THE INVENTION

[Description of Embodiments of Present Disclosure]

First, embodiments of the present disclosure are listed and described.

(1) The shield connector of the present disclosure is provided with a dielectric for accommodating an inner conductor and an outer conductor made of a metal plate material, the outer conductor surrounding the dielectric, the outer conductor including a box-shaped body portion and a receptacle projecting forward from a front wall portion of the body portion, a mating outer conductor being fit into the receptacle, and a rear end part of the receptacle and the front wall portion being continually and electrically conductively connected. Since the rear end part of the receptacle and the front wall portion of the body portion are continually and electrically conductively connected in the shield connector of the present disclosure, it is possible to prevent the leakage of noise at a boundary between the rear end part of the receptacle and the front wall portion of the body portion. Therefore, according to the present disclosure, an improvement in shielding performance can be realized.

(2) Preferably, the outer conductor includes a connecting portion projecting from the front wall portion, the connecting portion being connected to a circuit board. According to this configuration, a minimum length of a noise transmission path can be set between a front end part of the receptacle and the circuit board.

(3) Preferably, in (2), the receptacle includes an upper surface portion, a pair of left and right side surface portions extending downward from both left and right side edges of the upper surface portion and a pair of left and right lower surface portions horizontally extending from the pair of side surface portions, extending ends of the lower surface portions butting against each other, the front wall portion includes a pair of left and right front plate portions continually and individually connected to the pair of lower surface portions, and a left and right pair of the connecting portions individually project from the pair of left and right front plate portions. In a shield connector in which one connecting portion is connected to only one of left and right side surface portions, a noise transmission path from a receptacle to a circuit board is longer when noise from a mating outer conductor is transmitted to the side surface portion on a side not connected to the connecting portion since the noise transmission path goes through an upper surface portion and the side surface portion on the side connected to the connecting portion. In contrast, according to the configuration of the present disclosure, a noise transmission path from the receptacle to the circuit board is short even if noise transmitted to the receptacle from the mating outer conductor is transmitted to either one of the left and right side surface portions in a biased manner.

(4) Preferably, in (3), the pair of connecting portions are arranged laterally side by side, and the outer conductor includes a pair of left and right holding portions for holding the pair of left and right connecting portions in contact with each other. According to this configuration, one transmission path having a large cross-sectional area is constituted by the pair of connecting portions held in contact with each other. In this way, noise can be effectively reduced even if the noise transmitted to the receptacle from the mating outer conductor is transmitted to either one of the left and right side plate portions in a biased manner.

(5) Preferably, the outer conductor includes a first conductor portion constituting a part of the front wall portion, a second conductor portion constituting a part of the front wall portion and a flexible coupling portion relatively displaceably coupling a rear end edge of the first conductor portion and the second conductor portion, and at least one of the first and second conductor portions is formed with a resilient locking portion for holding a constituent part of the front wall portion in the first conductor portion and a constituent part of the front wall portion in the second conductor portion in contact. According to this configuration, the constituent part of the front wall portion in the first conductor portion and the constituent part of the front wall portion in the second conductor portion can be held in contact by the resilient locking portion. In this way, the leakage of noise in the front wall portion can be prevented.

(6) Preferably, the outer conductor includes a first conductor portion, a second conductor portion and a flexible coupling portion relatively displaceably coupling the first and second conductor portions, the first conductor portion includes a first side plate portion constituting the receptacle, a first arcuate portion formed on a lower end edge of the first side plate portion and constituting the receptacle and a lower plate portion extending from the first arcuate portion and constituting the receptacle, the second conductor portion includes a second side plate portion constituting the body portion, a second arcuate portion formed on a front end edge of the second side plate portion and covering an outer peripheral surface of the first arcuate portion and a second front plate portion extending from the second arcuate portion and constituting the front wall portion, and the outer peripheral surface of the first arcuate portion and an inner peripheral surface of the second arcuate portion have the same radius of curvature. According to this configuration, since there is no gap between the outer peripheral surface of the first arcuate portion and the inner peripheral surface of the second arcuate portion, it is possible to prevent the leakage of noise between the first and second arcuate portions.

[Details of Embodiment of Present Disclosure]

### Embodiment

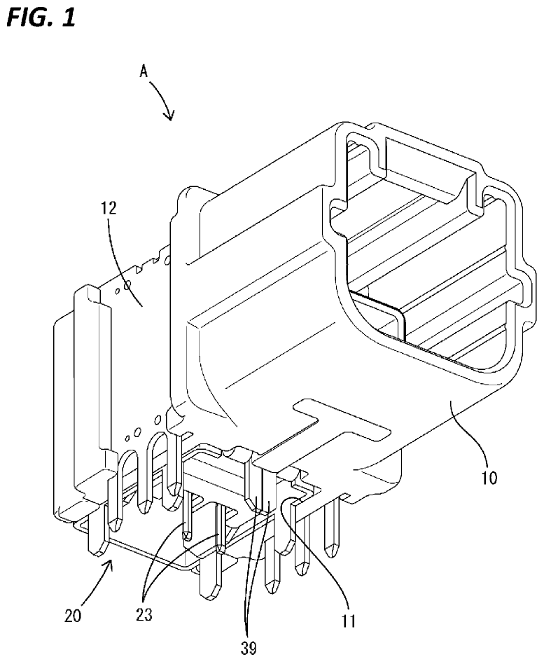

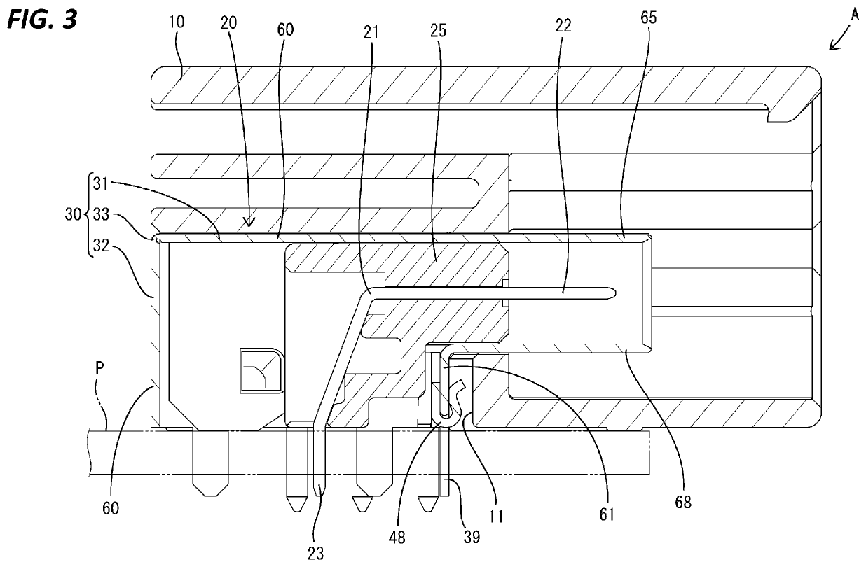

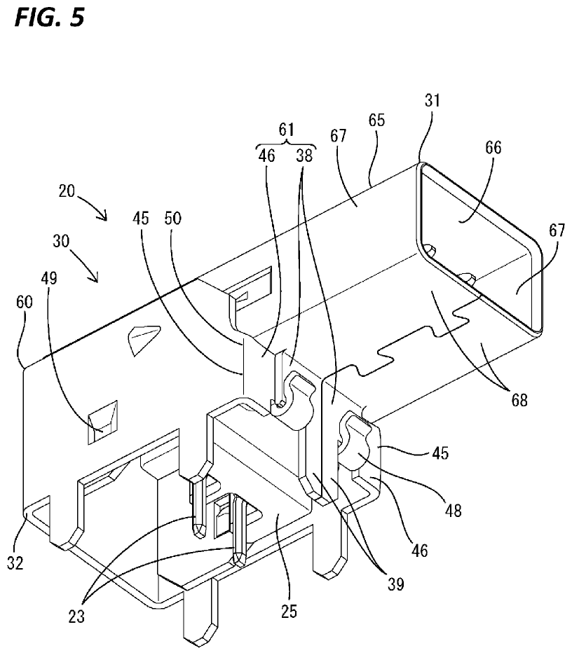

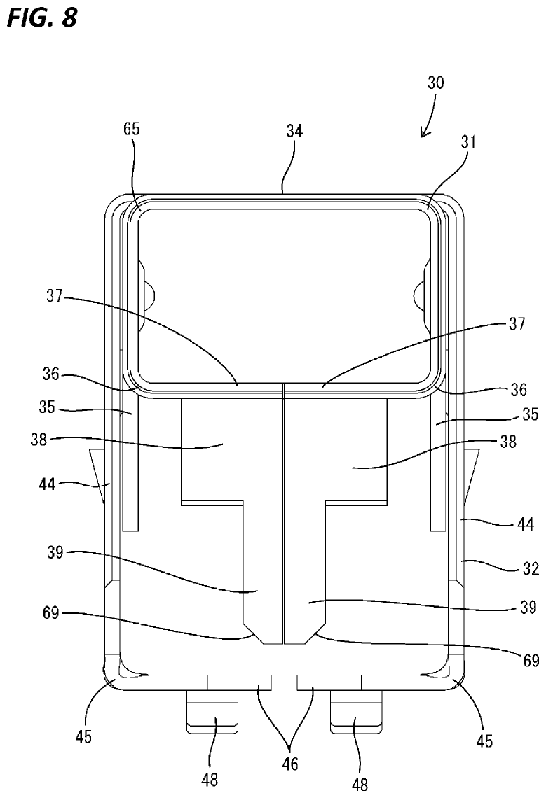

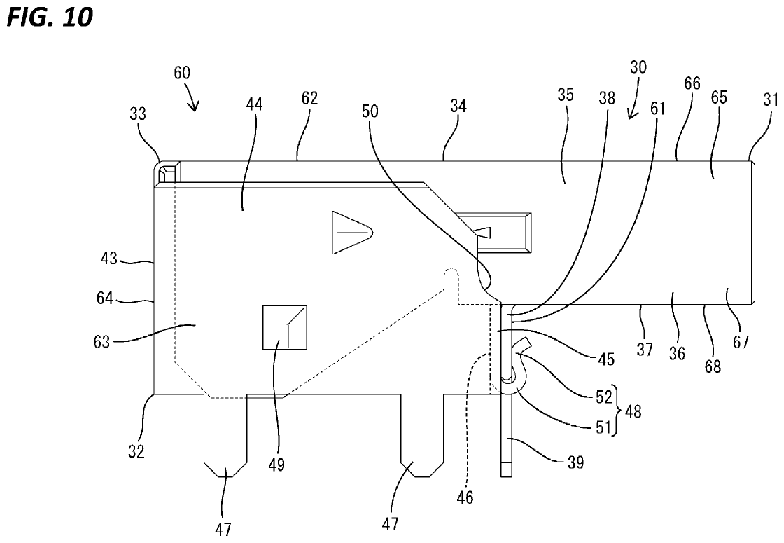

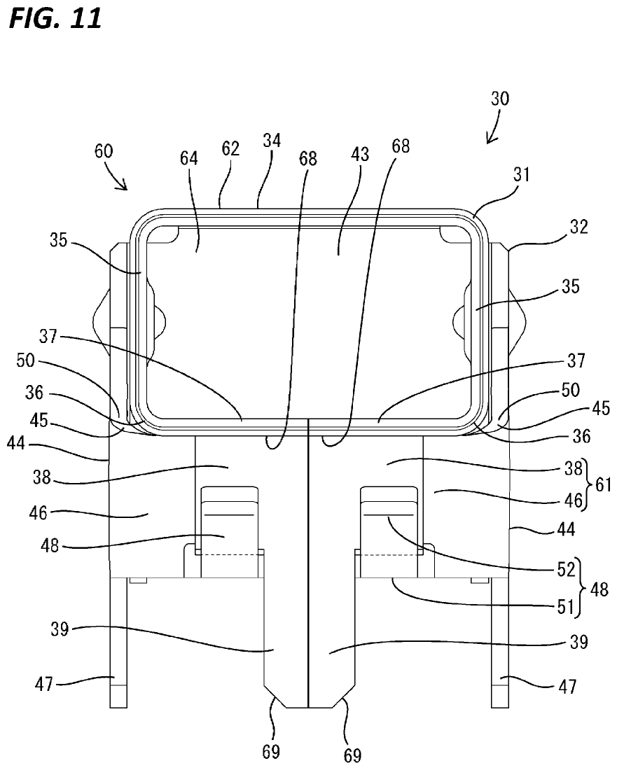

A specific embodiment of a shield connector of the present disclosure is described with reference to FIGS. 1 to 12. Note that the present invention is not limited to these illustrations, but is represented by claims and intended to include all changes in the scope of claims and in the meaning and scope of equivalents. In this embodiment, an oblique right-upper side in FIGS. 1, 2, 5 and 9 and a right side in FIGS. 3, 4, 6, 7, 10 and 12 are defined as a front side concerning a front-rear direction. Upper and lower sides shown in FIGS. 1 to 5 and 7 to 11 are directly defined as upper and lower sides concerning a vertical direction. Left and right sides shown in FIGS. 8 and 11 are directly defined as left and right sides concerning a lateral direction. The lateral direction and a width direction are used as synonyms.

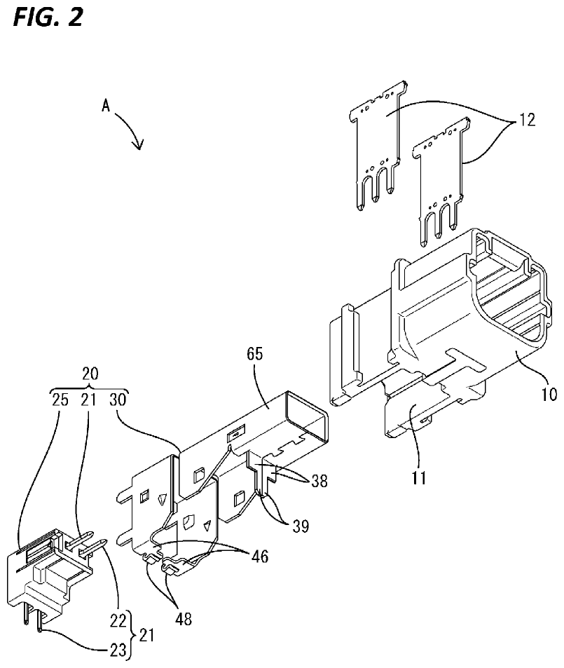

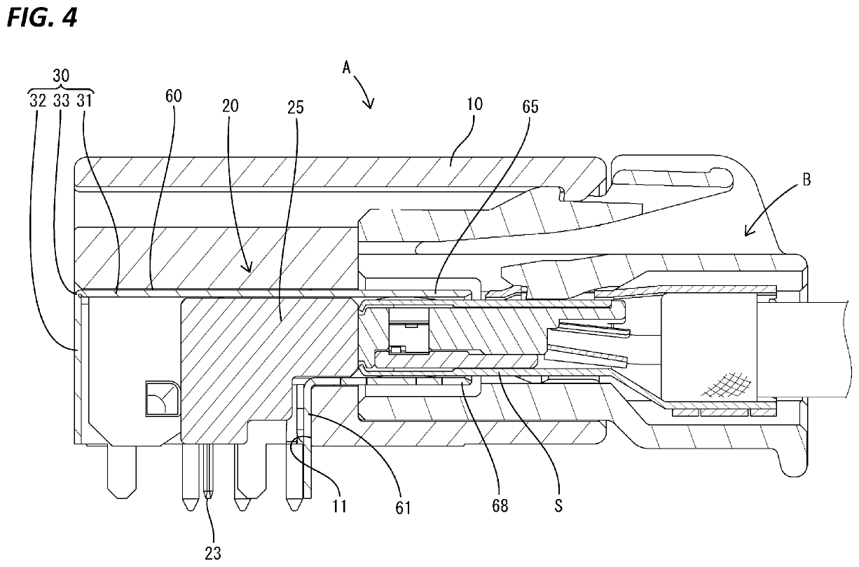

A shield connector A of this embodiment functions as a shield connector for board to be mounted on the upper surface of a circuit board P as shown in FIG. 3. As shown in FIG. 2, the shield connector A includes a housing 10 and a shield terminal 20. The housing 10 is a single component made of synthetic resin and in the form of a rectangular tube as a whole. The housing 10 has a shape penetrating in the front-rear direction. A lower surface opening 11 communicating with an opening in a rear surface is formed in a rear end side region of the lower surface of the housing 10. As shown in FIGS. 3 and 4, the shield terminal 20 is accommodated in the housing 10. As shown in FIG. 1, a pair of pegs 12 made of metal are mounted on both left and right outer side surfaces of the housing 10 by being press-fit.

The shield terminal 20 is configured by assembling a pair of left and right inner conductors 21, a dielectric 25 and an outer conductor 30. The inner conductor 21 is formed by bending an elongated metal material into an L shape. The dielectric 25 is a block-like component made of synthetic resin and L-shaped in a side view. Bent parts of the inner conductors 21 are accommodated in the dielectric 25. Tabs 25 of the inner conductors 21 project forward from the front surface of the dielectric 25. Board connecting portions 23 of the inner conductors 21 project downward from the lower surface of the dielectric 25.

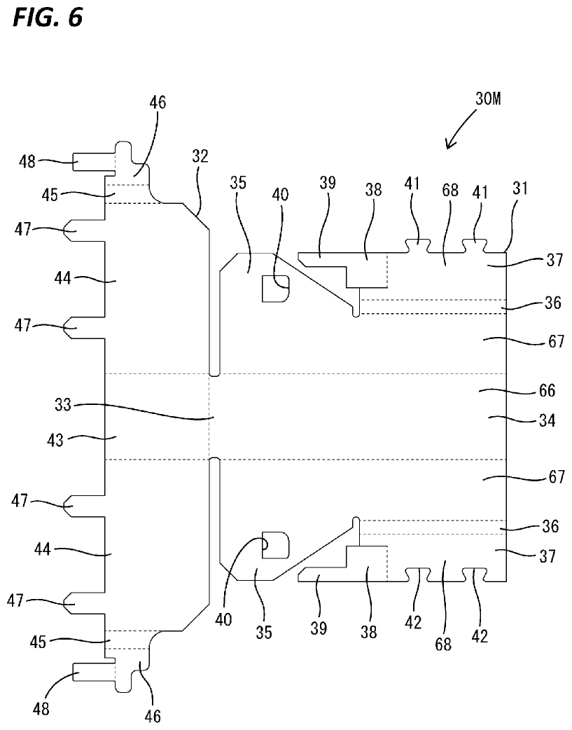

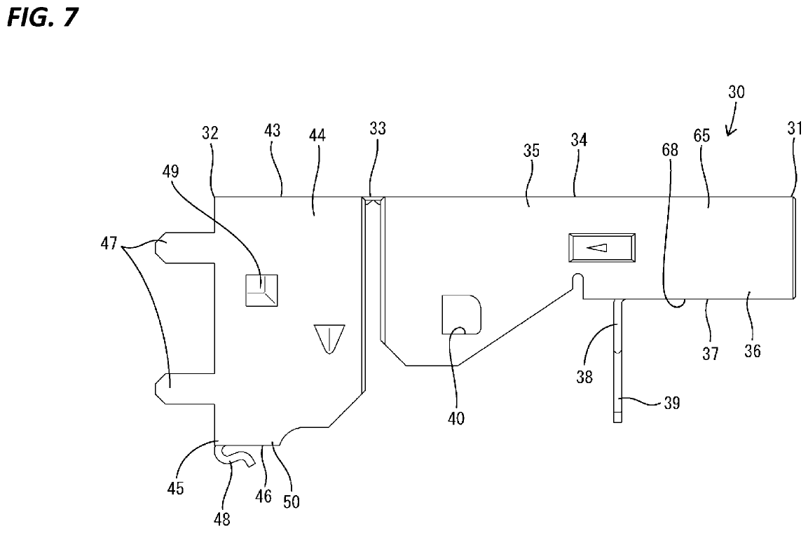

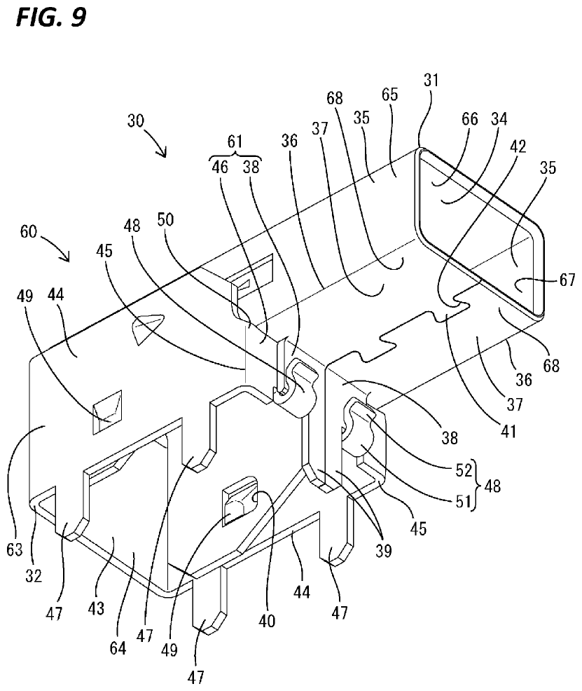

The outer conductor 30 is a single component formed by bending, cutting and raising, and striking a metal plate material 30M (see FIG. 6). As shown in FIGS. 6, 7 and 10, the outer conductor 30 structurally includes a first conductor portion 31, a second conductor portion 32 and a flexible coupling portion 33. The first and second conductor portions 31, 32 are coupled via the plastically deformable flexible coupling portion 33. The first and second conductor portions 31, 32 are relatively displaceable with the flexible coupling portion 33 as a fulcrum from a pre-assembled form (see FIGS. 7 and 8) in which the first and second conductor portions 31, 32 are not in contact with each other and an assembling completed form (see FIGS. 9 to 12) in which the first and second conductor portions 31, 32 are assembled and in contact with each other. When the first and second conductor portions 31, 32 are in the pre-assembled form, the outer conductor 30 is not completely formed yet. If the first and second conductor portions 31, 32 are relatively displaced to the assembling completed form, the outer conductor 30 is completely formed.

As shown in FIGS. 6 to 12, the first conductor portion 31 includes an upper plate portion 34 elongated in the front-rear direction, a pair of bilaterally symmetrical first side plate portions 35, a pair of bilaterally symmetrical first arcuate portions 36, a pair of left and right lower plate portions 37, a pair of bilaterally symmetrical first front plate portions 38 and a pair of bilaterally symmetrical first connecting portions 39. The pair of first side plate portions 35 extend downward perpendicularly from both left and right side edges of the upper plate portion 34. A front end side region of the first side plate portion 35 is rectangular. A rear end side region of the first side plate portion 35 is so shaped that a lower end edge is gradually lower toward the rear. As shown in FIGS. 6, 7 and 9, the pair of first side plate portions 35 are formed with locking holes 40.

The pair of left and right first arcuate portions 36 are connected to the lower end edges of the front end side regions of the pair of left and right first side plate portions 35 from the front ends to the rear ends of the front end side regions of the first side plate portions 35. As shown in FIGS. 8 and 11, the first arcuate portion 36 has a quarter-circular shape in a front view of the outer conductor 30. A radius of curvature of the outer peripheral surface of the first arcuate portion 36 is set to be sufficiently larger than a thickness of the metal plate material 30M.

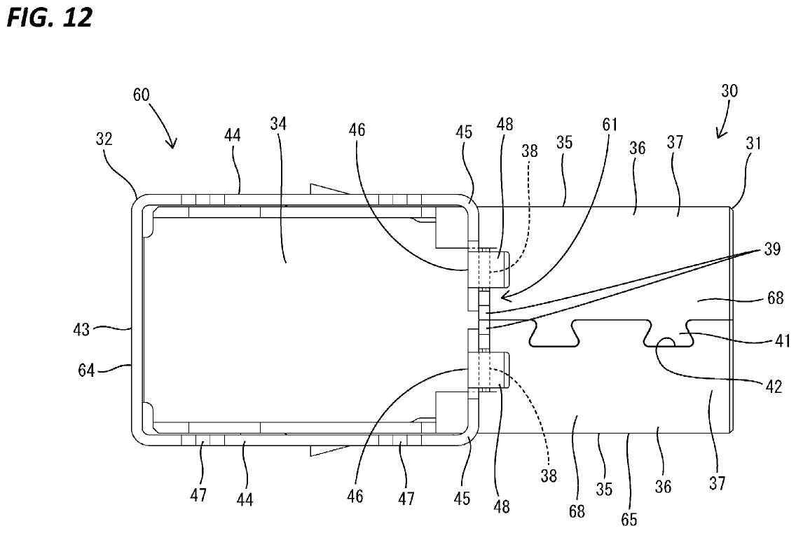

The pair of left and right lower plate portions 37 extend toward each other perpendicularly from the pair of left and right first arcuate portions 36. The pair of left and right lower plate portions 37 are connected to the pair of left and right first arcuate portions 36 over entire lengths from front ends to rear ends. As shown in FIGS. 9 and 12, trapezoidal fitting protrusions 41 are formed on an extending end edge part of one lower plate portion 37, and trapezoidal fitting recesses 42 are formed in an extending end edge part of the other lower plate portion 37. By fitting the fitting protrusions 41 and the fitting recesses 42, the pair of lower plate portions 37 are coupled to be flush with each other.

The pair of left and right first front plate portions 38 individually extend downward perpendicularly from the rear end edges of the pair of left and right lower plate portions 37. As shown in FIG. 7, the first front plate portions 38 are arranged at positions slightly forward of the rear ends of the lower plate portions 37. As shown in FIGS. 8 and 11, the front plate portion 38 has a square shape in a front view. Formation ranges of the first front plate portions 38 in the lateral direction are regions closer to a center than the both left and right first arcuate portions 36. Side edges of the pair of first front plate portions 38 butt against each other over entire heights from the upper ends to the lower ends of the first front plate portions 38. The pair of first front plate portions 38 are arranged laterally side by side while being flush with each other and electrically conductively in contact with each other.

As shown in FIGS. 8 and 11, the pair of left and right first connecting portions 39 individually project downward from the lower end edges of the pair of left and right first front plate portions 38. As shown in FIGS. 7 to 9, the first connecting portion 39 is connected to and flush with the first front plate portion 38. As shown in FIGS. 8 and 11, formation ranges of the first connecting portions 39 in the lateral direction are regions closer to a widthwise center than those of the both left and right first front plate portions 38. A width of the first connecting portion 39 is smaller than that of the first front plate portion 38. The pair of first connecting portions 39 are arranged laterally side by side to be flush with each other. The pair of first connecting portions 39 are electrically conductively in contact with each other over entire heights from the upper ends to the lower ends thereof.

As shown in FIGS. 6 to 12, the second conductor portion 32 includes a rear plate portion 43, a pair of bilaterally symmetrical second side plate portions 44, a pair of bilaterally symmetrical second arcuate portions 45, a pair of bilaterally symmetrical second front plate portions 46, two pairs of bilaterally symmetrical second connecting portions 47 and a pair of bilaterally symmetrical resilient locking portions 48. The vertical direction and front-rear direction in the following description are described, assuming that the first and second conductor portions 31, 32 are relatively displaced to the assembling completed form.

In a back view of the outer conductor 30, the rear plate portion 43 is rectangular. As shown in FIG. 6, the upper end edge of the rear plate portion 43 is coupled to the rear end edge of the upper plate portion 34 of the first conductor portion 31 via the flexible coupling portion 33 elongated in the lateral direction. As shown in FIG. 9, the rear plate portion 43 is arranged to close an opening in the rear surface of the first conductor portion 31. The pair of second side plate portions 44 extend forward perpendicularly from both left and right side edges of the rear plate portion 43. The second side plate portion 44 is sized and shaped to cover the entire rear end side region of the first side plate portion 35 from an outer surface side. The pair of second side plate portions 44 are formed with locking projections 49 projecting toward inner surface sides of the second side plate portions 44.

A front pair of the second connecting portions 47, out of two front and rear pairs, project downward from the lower end edge of the second side plate portion 44 on a left side and that of the second side plate portion 44 on a right side and are arranged at the same position in the front-rear direction. The front pair of second connecting portions 47 are arranged rearward of the front ends of the second side plate portions 44. The rear pair of the second connecting portions 47, out of the two front and rear pairs, project downward from the lower end edge of the second side plate portion 44 on the left side and that of the second side plate portion 44 on the right side and are arranged at the same position in the front-rear direction. The rear pair of second connecting portions 47 are arranged at positions rearward of the front second connecting portions 47 and forward of the rear ends of the second side plate portions 44.

The pair of left and right second arcuate portions 45 are connected to lower end side regions of the front end edges of the pair of left and right second side plate portions 44 over entire lengths from upper ends to lower ends. As shown in FIG. 12, the second arcuate portion 45 has a quarter-circular shape in a bottom view of the outer conductor 30. In a front view, a radius of curvature of the inner peripheral surface of the second arcuate portion 45 is set to be equal to that of the outer peripheral surface of the first arcuate portion 36. An upper end part of the second arcuate portion 45 functions as a covering portion 50 for covering a rear end part of the first arcuate portion 36 from outside. In a front view, the upper end edge of the covering portion 50 is curved to gradually rise from a widthwise center toward the outer side surface of the second side plate portion 44. In a side view of the outer conductor 30, the upper end edge of the covering portion 50 is curved to gradually rise from a front end toward a rear end. The curved upper end edge of the covering portion 50 is electrically conductively in contact with the outer peripheral surface of the rear end part of the first arcuate portion 36.

The pair of left and right second front plate portions 46 extend toward each other perpendicularly from the pair of left and right second arcuate portions 45. As shown in FIGS. 2 and 8, the extending ends of the pair of second front plate portions 46 are positioned to face each other in the lateral direction while being spaced apart from and not in contact with each other. The upper end edges of the pair of second front plate portions 46 are in contact with the lower surfaces of rear end parts of the pair of lower plate portions 37 without any gap. Parts on extending end sides, out of the pair of second front plate portions 46, are arranged to overlap in surface contact with the rear surfaces of the pair of first front plate portions 38. Parts on the sides of the second arcuate portions 45, out of the pair of second front plate portions 46, are located more outward than the first front plate portions 38 in the width direction.

The pair of left and right resilient locking portions 48 individually extend from the lower end edges of the pair of left and right second front plate portions 46. The resilient locking portion 48 is connected to a region where the first connecting portion 39 is not formed, out of the lower end edge of the first front plate portion 38, i.e. a region more outward than the first connecting portion 39 in the width direction. As shown in FIGS. 9 to 11, the resilient locking portion 48 includes a curved portion 51 and a contact point portion 52. The curved portion 51 has a semi-circular shape curved to bulge downward in a side view and projects forward of the second front plate portion 46 from the lower end edge of the second front plate portion 46. The front end edge of the curved portion 51 is located forward of the front surface of the first front plate portion 38. The contact point portion 52 has a bent shape to bulge rearward in a side view and is cantilevered upward from the front end edge of the curved portion 51.

The contact point portion 52 is in contact with the front surface of the first front plate portion 38 while resiliently deforming the curved portion 51. When the second front plate portion 46 and the resilient locking portion 48 are not in contact with the first front plate portion 38, a minimum interval in the front-rear direction between the second front plate portion 46 and the contact point portion 52 is set to be smaller than a plate thickness of the first front plate portion 38. Therefore, the second front plate portion 46 and the resilient locking portion 48 resiliently sandwich the first front plate portion 38 in the front-rear direction with the resilient locking portion 48 resiliently deformed. Due to a pressing force resulting from the resilience of the resilient locking portion 48, the front surface of the second front plate portion 46 is resiliently in contact with the rear surface of the first front plate portion 38 and the contact point portion 52 of the resilient locking portion 48 is resiliently in contact with the front surface of the first front plate portion 38.

The curved portions 51 of the pair of resilient locking portions 48 are resiliently in contact with upper end parts of the pair of first connecting portions 39 to sandwich these upper end parts in the width direction while resiliently deforming the pair of second side plate portions 44 outward in the width direction to expand a spacing. The pair of resilient locking portions 48 resiliently press the pair of first front plate portions 38 and the pair of first connecting portions 39 toward a widthwise central side by resilient restoring forces of the second side plate portions 44. Due to resilient pressing forces applied from the resilient locking portions 48, the pair of first front plate portions 38 are held in contact with each other and the pair of first connecting portions 39 are held in contact with each other. Since an interval is formed in the width direction between the pair of second front plate portions 46, the resilient restoring forces of the second side plate portions 44 reliably act on the first front plate portions 38 and the first connecting portions 39.

As shown in FIGS. 9 to 12, the outer conductor 30 functionally includes a rectangular body portion 60 with an open lower surface and a receptacle 65 in the form of a rectangular tube projecting forward from an upper end side region of the body portion 60. The body portion 60 includes a front wall portion 61, an upper wall portion 62, a pair of left and right side wall portions 63 and a rear wall portion 64. The body portion 60 is constituted by a part of the first conductor portion 31 and the entire second conductor portion 32. The body portion 60 includes a rear end side region of the upper plate portion 34, rear end side regions of the pair of first side plate portions 35, the pair of entire second side plate portions 44, the entire rear plate portion 43, the pair of entire first front plate portions 38, the pair of entire second arcuate portions 45 and the pair of entire second front plate portions 46.

The upper wall portion 62 is constituted by the rear end side region of the upper plate portion 34. The pair of side wall portions 63 include rear end side regions of the pair of first side plate portions 35, the pair of entire second side plate portions 44 and end edge parts connected to the second side plate portions 44, out of the pair of second arcuate portions 45. The rear wall portion 64 is constituted by the rear plate portion 43.

The front wall portion 61 includes the pair of entire first front plate portions 38, the pair of entire second front plate portions 46 and end edge parts connected to the second front plate portions 46, out of the pair of second arcuate portions 45. The second front plate portion 46 overlaps in surface contact with the rear surface of the first front plate portion 38 due to the resilience of the resilient locking portion 48. A widthwise central part of the front wall portion 61 is constituted by the pair of first front plate portions 38 and parts of the pair of second front plate portions 46. Both widthwise end parts of the front wall portion 61 are constituted by the pair of second front plate portions 46 and front end parts of the pair of second arcuate portions 45.

The pair of first connecting portions 39 project downward from the lower end edge of the front wall portion 61 while being electrically conductively integrated side by side in the lateral direction. The first connecting portions 39 are arranged forward of the two pairs of second connecting portions 47. The pair of first connecting portions 39 are located at the front end of the body portion 60, similarly to the front wall portion 61.

The receptacle 65 is constituted by a part of the first conductor portion 31. The second conductor portion 32 does not constitute the receptacle 65. In this embodiment, a region forward of the front wall portion 61 of the body portion 60, out of the outer conductor 30, is defined as the receptacle 65. The receptacle 65 projects forward from the front wall portion 61 and is arranged above the front wall portion 61. The receptacle 65 includes an upper surface portion 66, a pair of left and right side surface portions 67, lower surface portions 68 and the pair of left and right first arcuate portions 36. The upper surface portion 66 is constituted by a front end side region of the upper plate portion 34. The pair of side surface portions 67 are constituted by front end side regions of the pair of first side plate portions 35. The pair of first arcuate portions 36 are arranged along the lower end edges of the pair of side surface portions 67. A pair of the lower surface portions 68 are constituted by regions of the pair of lower plate portions 37 except rear end parts.

A rear end part of the receptacle 65 and an upper end part of the front wall portion 61 are electrically conductively connected perpendicular to each other without any gap. Rear end parts of the lower surface portions 68 constituting the receptacle 65 and upper end parts of the first front plate portions 38 constituting the front wall portion 61 are formed as an integral part free from any cut and any gap. The rear end parts of the lower surface portions 68 and upper end parts of the second front plate portions 46 constituting the front wall portion 61 are formed as different parts via cuts, but are electrically conductively in contact without any gap. Rear end parts of the outer peripheral surfaces of the first arcuate portions 36 constituting the receptacle 65 and upper end parts of the second arcuate portions 45 constituting the body portion 60 are formed as different parts via cuts, but are electrically conductively in contact without any gap.

The shield terminal 20 is assembled as follows. The outer conductor 30 is formed by applying bending and the like to the metal plate material 30M and, as shown in FIG. 7, the first and second conductive portions 31, 32 are set in the pre-assembled form. In the pre-assembled form, the receptacle 65 is in a final shape, but the body portion 60 is not formed yet. In the pre-assembled form, the second conductive portion 32 is arranged behind the first conductive portion 31 via the flexible coupling portion 33 and the rear plate portion 43 is arranged at the same height as the upper plate portion 34. In this state, the dielectric 25 assembled with the inner conductors 21 is accommodated into the first and second arcuate portions 31, 32 from below the outer conductor 30. Subsequently, the inner conductors 21 and the dielectric 25 are slid forward and a front end side part of the dielectric 25 and the tabs 22 of the inner conductors 21 are accommodated into the receptacle 65.

Thereafter, the second conductive portion 32 is turned forward 90° with the flexible coupling portion 33 as a fulcrum, turned to the assembling completed form and assembled with the first conductive portion 31. In an assembling process, the second side plate portions 44 are overlapped on the outer side surfaces of the first side plate portions 35, and the second front plate portions 46 and the resilient locking portions 48 approach the first front plate portions 38 and first connecting portions 39 along arcuate paths. Immediately before the second conductive portion 32 reaches the assembling completed form, tip parts of the contact point portions 52 of the resilient locking portions 48 come into contact with guiding portions 69 (see FIG. 8) formed on lower end parts of the first connecting portions 39.

If a relative displacement of the second conductive portion 32 progresses from this state, the curved portions 51 of the pair of resilient locking portions 48 slide in contact with the pair of guiding portions 69, whereby the pair of second side plate portions 44 are resiliently deformed to expand the spacing. If the resilient locking portions 48 pass over the guiding portions 69, the curved portions 51 slide in contact with regions above the guiding portions 69, out of the side edges of the first connecting portions 39. Thereafter, the contact point portions 52 come into contact with the lower end parts of the first front plate portions 38. If the relative displacement of the second conductive portion 32 further progresses from this state, the contact point portions 52 slide in contact with the front surfaces of the first front plate portions 38 while the resilient locking portions 48 are resiliently deformed.

If the first and second conductive portions 31, 32 are displaced to the assembling completed form, the outer conductor 30 is completely formed and, simultaneously, the outer conductor 30, the dielectric 25 and the inner conductors 21 are assembled to complete the assembling of the shield terminal 20. The first and second conductive portions 31, 32 are held in the assembling completed form by the locking of the locking holes 40 and the locking projections 49. The board connecting portions 23 of the inner conductors 21 project downward from the open lower surface of the body portion 60. The first and second connecting portions 39, 47 project downward from the lower end of the body portion 60.

The shield terminal 20 assembled as described above is mounted into the housing 10 from behind. The shield connector A is configured by mounting the shield terminal 20 into the housing 10. With the shield terminal 20 mounted in the housing 10, the body portion 60 is exposed in the lower surface opening 11 of the housing 10. The board connecting portions 23 of the inner conductors 21 and the first and second connecting portions 39, 47 of the outer conductor 30 project downward from the lower surface opening 11.

The shield connector A is mounted with the housing 10 placed on the upper surface of the circuit board P (not shown). The housing 10 is fixed to the circuit board P by soldering the pegs 12 to the circuit board P. The board connecting portions 23 of the inner conductors 21 and the first and second connecting portions 39, 47 of the outer conductor 30 are inserted into through holes (not shown) of the circuit board P and electrically conductively fixed by soldering. As shown in FIG. 4, a mating outer conductor S of a mating connector B is electrically conductively fit into the receptacle 65.

The shield connector A of this embodiment is provided with the dielectric 25 for accommodating the inner conductors 21 and the outer conductor 30 made of the metal plate material 30M and surrounding the dielectric 25. The outer conductor 30 includes the box-shaped body portion 60 and the receptacle 65, into which the mating outer conductor S is fit. The receptacle 65 projects forward from an upper end side region of the front wall portion 61 of the body portion 60. The rear end part of the receptacle 65 and the front wall portion 61 of the body portion 60 are continually and electrically conductively connected. Since the shield connector A of this embodiment uses the outer conductor 30 made of the metal plate material 30M, cost can be suppressed as compared to a shield connector using an outer conductor formed by die casting.

Since the mating outer conductor S is fit into the receptacle 65, the receptacle 65 needs to be arranged on the outer surface of the outer conductor 30. Similarly to the receptacle 65, the front wall portion 61 of the body portion 60, from which the receptacle 65 projects, is also arranged on the outer surface of the outer conductor 30. To enhance shielding performance, the leakage of noise at a boundary between the receptacle 65 and the front wall portion 61 needs to be prevented. Since the rear end part of the receptacle 65 and the front wall portion 61 of the body portion 60 are continually and electrically conductively connected in the shield connector A of this embodiment, the leakage of noise at a boundary between the rear end part of the receptacle 65 and the front wall portion 61 can be prevented. Therefore, according to the shield connector A of this embodiment, an improvement in shielding performance can be realized.

Noise transmission paths between a front end part of the receptacle 65 and the circuit board P are composed of first transmission paths from the rear end part of the receptacle 65 via the front wall portion 61 and the first connecting portions 39 and second transmission paths from the rear end part of the receptacle 65 via the side wall portions 63 and the second connecting portions 47. A creepage distance between the first connecting portion 39 and the rear end part of the receptacle 65 is shorter than that between the second connecting portion 47 and the rear end part of the receptacle 65. Therefore, the first transmission paths including the first connecting portions 39 constitute shortest noise transmission paths between the rear end part of the receptacle 65 and the circuit board P.

The receptacle 65 includes the upper surface portion 66, the pair of left and right side surface portions 67 extending downward from both left and right side edges of the upper surface portion 66, and the pair of left and right lower surface portions 68 horizontally extending from the pair of side surface portions 67 and having the extending ends butted against each other. The front wall portion 61 includes the pair of left and right first front plate portions 38 individually and continually connected to the pair of lower surface portions 68. The pair of left and right first connecting portions 39 individually project from the pair of left and right first front plate portions 38. If one connecting portion is connected to only either one of the left and right side surface portions 67, a noise transmission path from the receptacle 65 to the circuit board P is longer since this noise transmission path goes through the upper surface portion 66 and the side surface portion 67 on the side connected to the connecting portion when noise transmitted to the receptacle 65 from the mating outer conductor S is transmitted to the side surface portion 67 on the side not connected to the connecting portion. In contrast, according to the shield connector A of this embodiment, even if noise transmitted from the mating outer conductor S to the receptacle 65 is transmitted to either one of the left and right side surface portions 67 in a biased manner, the noise transmission path from the receptacle 65 to the circuit board P is shorter.

The pair of first connecting portions 39 are arranged laterally side by side. The outer conductor 30 includes the pair of left and right resilient locking portions 48. The pair of resilient locking portions 48 also function as holding portions for holding the pair of left and right first connecting portions 39 in contact with each other. According to this configuration, one conductive path having a wide cross-sectional area is constituted by the pair of first connecting portions 39 held in contact with each other. Therefore, even if noise transmitted from the mating outer conductor S to the receptacle 65 is transmitted to either one of the left and right side surface portions 67 in a biased manner, the noise can be effectively reduced.

The outer conductor 30 includes the first conductor portion 31, the second conductor portion 32 and the flexible coupling portion 33. The first conductor portion 31 constitutes a part of the front wall portion 61. The second conductor portion 32 constitutes a part of the front wall portion 61. The flexible coupling portion 33 relatively displaceably couples the rear end edge of the first conductor portion 31 and the second conductor portion 32. The second conductor portion 32 is formed with the resilient locking portions 48. The resilient locking portions 48 hold the first front plate portions 38, which are constituent parts of the front wall portion 61 in the first conductor portion 31, and the second front plate portions 46, which are constituent parts of the front wall portion 61 in the second conductor portion 32, in contact. Since the first and second front plate portions 38, 46 can be held in contact by the resilient locking portions 48, the leakage of noise in the front wall portion 61 can be prevented.

The outer conductor 30 includes the first conductor portion 31, the second conductor portion 32 and the flexible coupling portion 33 relatively displaceably coupling the first and second conductor portions 31, 32. The first conductor portion 31 includes the pair of first side plate portions 35 constituting the receptacle 65, the pair of first arcuate portions 36 and the pair of lower plate portions 37. The pair of first arcuate portions 36 are formed on the lower end edges of the first side plate portions 35 and constitute the receptacle 65. The pair of lower plate portions 37 extend from the first arcuate portions 36 and constitute the receptacle 65. The second conductor portion 32 includes the pair of second side plate portions 44 constituting the body portion 60, the pair of second arcuate portions 45 and the pair of second front plate portions 46. The pair of second arcuate portions 45 are formed on the front end edges of the second side plate portions 44 and cover the outer peripheral surfaces of the first arcuate portions 36. The pair of second front plate portions 46 extend from the second arcuate portions 45 and constitute the front wall portion 61. In a front view of the first arcuate portion 36 viewed in parallel to a length direction, the radius of curvature of the outer peripheral surface of the first arcuate portion 36 and that of the inner peripheral surface of the second arcuate portion 45 are equal. According to this configuration, since there is no gap between the outer peripheral surface of the first arcuate portion 36 and the inner peripheral surface of the second arcuate portion 45, it is possible to prevent the leakage of noise between the first and second arcuate portions 36, 45.

[Other Embodiments]

The present invention is not limited to the above described and illustrated embodiment, but is represented by claims. The present invention is intended to include all changes in the scope of claims and in the meaning and scope of equivalents and also include the following embodiments.

Although the connecting portions projecting from the front wall portion are provided in the above embodiment, the connecting portions may be arranged only in a region behind the front wall portion.

Although the pair of connecting portions (first leg portions) are arranged laterally side by side in the above embodiment, the pair of connecting portions may overlap in contact with each other in the front-rear direction.

Although the resilient locking portions are formed only in the second conductor portion in the above embodiment, the resilient locking portions may be formed only in the first conductor portion or may be formed in both the first and second conductor portions.

### LIST OF REFERENCE NUMERALS

. . . A shield connector
. . . B mating connector
. . . L side cross-section
. . . P circuit board
. . . S mating outer conductor
10 . . . housing
11 . . . lower surface opening
12 . . . peg
20 . . . shield terminal
21 . . . inner conductor
22 . . . tab
23 . . . board connecting portion
25 . . . dielectric
30 . . . outer conductor
30M . . . metal plate material
31 . . . first conductor portion
32 . . . second conductor portion
33 . . . flexible coupling portion
34 . . . upper plate portion
35 . . . first side plate portion
36 . . . first arcuate portion
37 . . . lower plate portion
38 . . . first front plate portion (constituent part of front wall portion in first conductor portion)
39 . . . first connecting portion (connecting portion)
40 . . . locking hole
41 . . . fitting protrusion
42 . . . fitting recess
43 . . . rear plate portion
44 . . . second side plate portion
45 . . . second arcuate portion
46 . . . second front plate portion (constituent part of front wall portion in second conductor portion)
47 . . . second connecting portion
48 . . . resilient locking portion (holding portion)
49 . . . locking projection
50 . . . covering portion
51 . . . curved portion
52 . . . contact point portion
60 . . . body portion
61 . . . front wall portion
62 . . . upper wall portion
63 . . . side wall portion
64 . . . rear wall portion
65 . . . receptacle
66 . . . upper surface portion
67 . . . side surface portion
68 . . . lower surface portion
69 . . . guiding portion

1. A shield connector, comprising:
a dielectric for accommodating an inner conductor; and
an outer conductor made of a metal plate material, the outer conductor surrounding the dielectric,
the outer conductor including a box-shaped body portion and a receptacle projecting forward from a front wall portion of the body portion, a mating outer conductor being fit into the receptacle, and
a rear end part of the receptacle and the front wall portion being continually and electrically conductively connected.

2. The shield connector of claim 1, wherein the outer conductor includes a connecting portion projecting from the front wall portion, the connecting portion being connected to a circuit board.

3. The shield connector of claim 2, wherein:
the receptacle includes an upper surface portion, a pair of left and right side surface portions extending downward from both left and right side edges of the upper surface portion and a pair of left and right lower surface portions horizontally extending from the pair of side surface portions, extending ends of the lower surface portions butting against each other,
the front wall portion includes a pair of left and right front plate portions continually and individually connected to the pair of lower surface portions, and
a left and right pair of the connecting portions individually project from the pair of left and right front plate portions.

4. The shield connector of claim 3, wherein:
the pair of connecting portions are arranged laterally side by side, and
the outer conductor includes a pair of left and right holding portions for holding the pair of left and right connecting portions in contact with each other.

5. The shield connector of claim 1, wherein:
the outer conductor includes a first conductor portion constituting a part of the front wall portion, a second conductor portion constituting a part of the front wall portion and a flexible coupling portion relatively displaceably coupling a rear end edge of the first conductor portion and the second conductor portion, and
at least one of the first and second conductor portions is formed with a resilient locking portion for holding a constituent part of the front wall portion in the first conductor portion and a constituent part of the front wall portion in the second conductor portion in contact.

6. The shield connector of claim 1, wherein:
the outer conductor includes a first conductor portion, a second conductor portion and a flexible coupling portion relatively displaceably coupling the first and second conductor portions,
the first conductor portion includes a first side plate portion constituting the receptacle, a first arcuate portion formed on a lower end edge of the first side plate portion and constituting the receptacle and a lower plate portion extending from the first arcuate portion and constituting the receptacle,
the second conductor portion includes a second side plate portion constituting the body portion, a second arcuate portion formed on a front end edge of the second side plate portion and covering an outer peripheral surface of the first arcuate portion and a second front plate portion extending from the second arcuate portion and constituting the front wall portion, and
the outer peripheral surface of the first arcuate portion and an inner peripheral surface of the second arcuate portion have the same radius of curvature.
